(19) United States
(12) Patent Application Publication
(10) Pub. No.: US 2004/0234340 A1
(43) Pub. Date: Nov. 25, 2004

(54) Mobile levee system

(76) Inventors: Yong Min Cho, Silver Spring, MD (US); Philip Y. Kim, Silver Spring, MD (US)

Correspondence Address: Mr. Yong Min Cho, 16605 Sea Island Court, Silver Spring, MD, 20905, US

(21) Appl. No.: 10/441,210

(22) Filed: May 20, 2003

(51) Int. Cl. F16D 1/12; E02B 7/02

(52) U.S. Cl. 405/107; 405/112; 405/115

(57) ABSTRACT

Every year, during the summer and fall seasons, we experience heavy rainfall and floods. Whenever we have heavy rainfalls, we worry about the streets flooding and the safety of the levees. The flooding of streets and cities results in the loss of human life, as well as a loss in millions of dollars of property. The mobile levee system will protect the streets, properties, and cities from flood. It is easy and quick to install, and it is more secure than sand bags. The mobile levee system will protect millions of dollars in property as well as save human lives.

### BACKGROUND OF THE INVENTION

Every year, during the summer and fall seasons, we experience heavy rainfalls and flooding. Whenever there is heavy rainfall, the problems of flooding streets and the safety of levees arise. The flooding of streets and cities results in the loss of human life and millions of dollars worth of property damage. The mobile levee system will protect streets, properties, and cities from floods. It may also be used to provide levees with extra height in place of sand bags. It is easy and quick to install, more secure than sand bags, and it gives us protection from floods. It will protect millions of dollars worth of property and may even save human lives.

### SUMMARY OF THE INVENTION

The primary objective of this invention is to provide a mobile levee system, which will be able to protect property from floods. The system uses New Jersey type concrete walls and a long rubber-lining airbed. The New Jersey type wall will sit on the long rubber-lining flat airbed. The Jersey wall is the first levee wall. Air will be pumped into the airbed, and this will serve as a second wall. The airbed will seal the gaps between concrete wall bottoms and the ground and in between the wall sections.

### BRIEF DESCRIPTION OF THE DRAWING

This invention can be fully understood through references to the following eight figures and their brief descriptions below:

FIG. 1 is a conceptual side view of a New Jersey type concrete wall.

FIG. 2 is a conceptual side view of an inflated long rubber-lining flat airbed.

FIG. 3 is a conceptual side view of the New Jersey type concrete wall sitting on an inflated long rubber-lining flat airbed.

FIG. 4 is a conceptual view of an inflated long rubber-lining flat airbed.

FIG. 5 is conceptual view of multiple New Jersey type concrete walls connected.

FIG. 6 is a conceptual view of a deflated long rubber-lining flat airbed.

FIG. 7 is a conceptual view of a New Jersey type concrete wall sitting on a deflated long rubber-lining flat airbed.

FIG. 8 is a conceptual side view of a New Jersey type concrete wall sitting on an inflated long rubber-lining flat airbed, serving as the mobile levee.

### DETAILED DESCRIPTION OF THE DRAWING

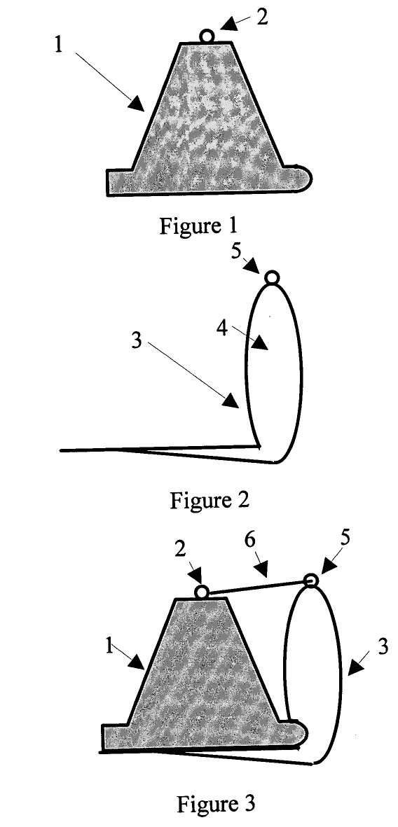

In FIGS. 1 and 5, the New Jersey type concrete wall 1 has attachment rings 2. The attachment rings can be used to help transport the New Jersey type concrete walls. It will also be used for securing the long rubber-lining flat airbed.

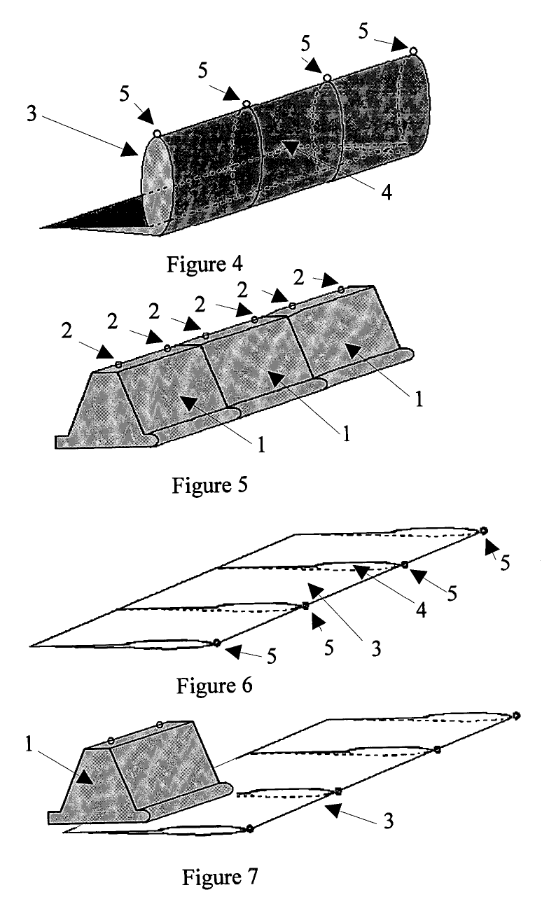

In FIGS. 2, 4, and 6, the long rubber-lining flat airbed 3 with an airbag 4 has attachment rings 5, which will be used to secure the airbag to the New Jersey type concrete wall.

In FIG. 3, a New Jersey type concrete wall 1 sitting on the long rubber-lining flat airbed 3 is secured by string 6, connected between the rings 2 on the wall and the rings 5 on the airbed.

In FIG. 7, a New Jersey type concrete wall 1 sits on the long rubber-lining flat airbed 3.

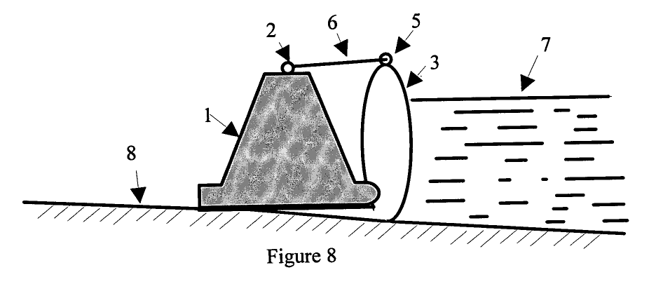

In FIG. 8, a New Jersey type concrete wall 1 sitting on the long rubber-lining flat airbed 3 is secured by string 6 connected between rings 2 on the wall and rings 5 on the airbed. The long rubber-lining flat airbed 3 lies on the riverbed 8 and serves as a levee, blocking the water 7.

I claim:

1. A mobile levee system that uses New Jersey type concrete walls and rubber-lining airbeds.

2. Any shape, size, and materials of the New Jersey type concrete walls covered in claim 1.

3. Any shape, size, and materials of the rubber-lining airbed covered in claim 1.
